(19) United States
(12) Patent Application Publication
(10) Pub. No.: US 2014/0329655 A1
(43) Pub. Date: Nov. 6, 2014

(54) Methods and Apparatus for Producing Stretch Films with Improved Protection From Tear Propagation

(71) Applicant: PARAGON FILMS, INC., Broken Arrow, OK (US)

(72) Inventor: Shaun Eugene Pirtle, Coweta, OK (US)

(73) Assignee: PARAGON FILMS, INC., Broken Arrow, OK (US)

(21) Appl. No.: 14/267,228

(22) Filed: May 1, 2014

Related U.S. Application Data
(60) Provisional application No. 61/818,299, filed on May 1, 2013.

(51) Int. Cl. B31F 1/00

(52) U.S. Cl. CPC B31F 1/0029
USPC 493/360; 493/406

(57) ABSTRACT

A method of folding an interior section of film in-process includes at least the following steps: separating an idler roll and a rolling assembly; positioning an interior web folding assembly between the idler roll and the rolling assembly; passing a film web from the idler roll to the interior web folding assembly; initiating at least one interior fold in the film web using the interior web folding assembly; passing the film web from the interior web folding assembly to the rolling assembly; and passing the film web beyond the rolling assembly, compressing the film web, and completing the at least one interior fold. An apparatus for folding an interior section of film includes at least: an idler roll separated from a rolling assembly; and an interior web folding assembly positioned between the idler roll and the rolling assembly.

### FIELD

The present invention relates generally to stretch films and methods for producing stretch films, and in a particular though non-limiting embodiment, to a stretch film and associated method for producing stretch films wherein folds are introduced into the interior of the film web in-process, thereby resulting in a film with improved protection from tear propagation and rendering the film less susceptible to film failure.

### BACKGROUND

Stretch films are widely used in a variety of bundling and packaging applications. For example, stretch films have become a common method of securing bulky loads such as boxes, merchandise, produce, equipment, parts, and other similar items on pallets. Such films are typically made from various polyethylene resins and are single or multilayer products. An additive known as a cling agent is frequently used to ensure that adjacent layers of film will cling to each other.

The ability of a stretch film to secure a load to a pallet and prevent the load from shifting, deforming, and/or falling apart is dependent on several variables, including the gauge (i.e., thickness) of the film, the amount the film is stretched or oriented prior to being wrapped around the load, the amount of force applied to the film as it is being wrapped around the load, the number of layers of film being applied to the load, and the inherent physical properties of the film.

An important element that affects the quality of a stretch film is the level of load containment force that can be applied to the film without it failing (“load containment force” is also referred to herein as “load retention force” or “load holding force”). Load containment force is the force exerted on the load, after the film has been applied to the load and allowed to relax for a prescribed length of time. A heavier or larger load requires a higher load containment force in order to prevent shifting of the product on the pallet or product damage. The required level of load containment force is bracketed between an upper range where excessive force could potentially deform the product, and an insufficient level of force resulting in a loss of containment due to film relaxation. Load retention force is one of the most significant and important properties of a stretch film. As the load retention force is decreased, the chance of the load shifting, deforming, and/or falling apart is increased.

The load containment force is applied to the film via the rotation of the load or the rotation of the film-dispensing unit, depending on the type of equipment used, while drag or braking is applied to the film roll as it is unwound. The level of force that can be applied is a function of the inherent properties of the stretch film in relation to the specific elongation of the film achieved during the stretching process. These inherent properties include, but are not limited to, extensibility, how far the film can be stretched before it breaks (i.e., ultimate elongation), how much force is required to stretch the film at a prescribed level of elongation (i.e., force-to-stretch), and how much residual force is left in the film after the film has been applied to the load. These properties are influenced by factors such as the type, molecular weight, and density of the resin(s) making up the film, the number of layers in the film, the relative percentage of each layer and how the layers are combined, the overall gauge of the film, and fabrication variables, such as draw down ratio and quench rate.

Secondary factors that affect film performance include, but are not limited to, the type and geometry of the load being wrapped, the speed at which the film is unwound and the percent of elongation (i.e., deformation rate), the type of equipment used to wrap the load, the amount of slippage of the film as it is stretched, and any film deformities that could lead to premature failure.

In order to increase the amount of load containment force that can be applied to a conventional stretch film, an end-user has the option of using more film, either by wrapping additional layers of film around a load, or selecting a thicker film. Alternatively, an end-user has the option of stretching the film to a point near its ultimate elongation point. However, stretching a film until it is near its ultimate elongation point imparts high levels of stress and orientation to the film. As a result, the film is vulnerable to defects, abuse, and excessive stretching, and is thus more likely to fail.

Furthermore, users of stretch film are constantly looking for methods and films that decrease the price and time required to wrap a load. However, the current methods of reducing price and time are incongruent with increasing the amount of load containment force that can be applied to the film. Current methods used to decrease the price and time required to wrap a load include: reducing the gauge of the film, reducing the number of wraps applied to the load, and increasing the stretch level of the film.

Therefore, if the gauge of the film or the number of wraps applied to the load is decreased, the film's inherent properties, such as available load holding force, must be improved.

Methods currently known in the art for increasing the load holding force that can be applied to a stretch film include utilizing higher performance resins, which permit the film to be produced at reduced gauges and to be stretched further before failing. The main issues associated with these methods include the increased cost of the higher performance resin(s) and the fact that the thinner the film is and the more it is stretched, the more likely it is to fail during the application process.

Further, as films are decreased in gauge, the increased level of machine direction orientation induced into the films during fabrication makes the films more prone to cross directional failures due to edge damage, contamination, gels, or any issues that the end user may encounter with the associated equipment during the application process.

One method known in the art for decreasing the susceptibility to failure of thin gauge films is to fold the edges of the film. By utilizing edge folds, the folded edge is exposed to any abuse or distortion, as opposed to the thinner gauge film body. Further, the film thickness is essentially doubled at the most vulnerable section of the film, resulting in a higher resistance to tear initiation and propagation. These characteristics ultimately translate into less film failures. This technology has been employed in the stretch film industry to maintain or even reduce the average weight of the films versus a traditional film of uniform thickness without folded edges.

However, one issue with films that have folded edges is that the film is twice as thick in the folded regions, resulting in gauge bands when the film is wound. These gauge bands can cause difficulties in unwinding the film, including blocking and film failure. The gauge bands also result, in some cases, in core crushing and difficulty in removing the film roll from the shaft during production. To minimize these issues, there is a patented method for oscillating the film as it is rolled, which allows the thickened section to be distributed over a wider area. See U.S. Pat. No. 8,100,356.

There is, therefore, a long-standing yet unmet need for stretch films with improved physical properties, which allows a load to be unitized in a cost and time efficient manner. There is a further unmet need for methods of producing such improved stretch films.

### SUMMARY

Methods and apparatus for folding an interior section of film in-process are provided. The method includes at least the following steps: separating an idler roll and a rolling assembly; positioning an interior web folding assembly between the idler roll and the rolling assembly; passing a film web from the idler roll to the interior web folding assembly; initiating at least one interior fold in the film web using the interior web folding assembly; passing the film web from the interior web folding assembly to the rolling assembly; and passing the film web beyond the rolling assembly, compressing the film web, and completing the at least one interior fold.

The apparatus includes at least: an idler roll separated from a rolling assembly; and an interior web folding assembly positioned between the idler roll and the rolling assembly.

### BRIEF DESCRIPTION OF THE DRAWINGS

For a further understanding of the nature, objects and advantages of the present invention, reference should be had to the following descriptions read in conjunction with the following drawings:

FIG. 1 illustrates the steps for producing film in-process according to an example embodiment disclosed herein;

FIG. 2 illustrates an edge folding assembly and an interior web folding assembly, according to an example embodiment disclosed herein.

FIG. 3 illustrates the side view of a film web with one interior fold, according to example embodiments; and

FIG. 4 illustrates the side view of a film web with multiple interior folds, according to example embodiments.

### DETAILED DESCRIPTION

The following description is not to be taken in a limiting sense, but is made merely for the purpose of illustrating example embodiments.

According to example embodiments, apparatus and methods for producing film in-process for use in the stretch film market are provided. According to further example embodiments, apparatus and methods are described for introducing at least one Z-shaped fold in an interior portion of the film in-process.

According to further embodiments, a method of folding an interior section of film in-process is disclosed. In certain embodiments, the method includes passing a film web through an interior web folding assembly, initiating at least one interior fold in the film web using the interior web folding assembly, and subsequently compressing the film web until the at least one interior fold is completed. In further embodiments, the film web is pressed until at least one interior fold is completed.

In still further example embodiments, multiple film rolls are folded simultaneously using the disclosed apparatus and methods. In alternative example embodiments, interior folds increase the ease of use of the film and reduce waste by making the film less susceptible to failure due to tears, rough handling, or excessive stretching.

According to one example embodiment, the load holding force that can be applied to a stretch film is increased using the described methods.

According to a further example embodiment, the load holding force that can be applied to a stretch film is increased by introducing one or more folds into an interior portion of the film web.

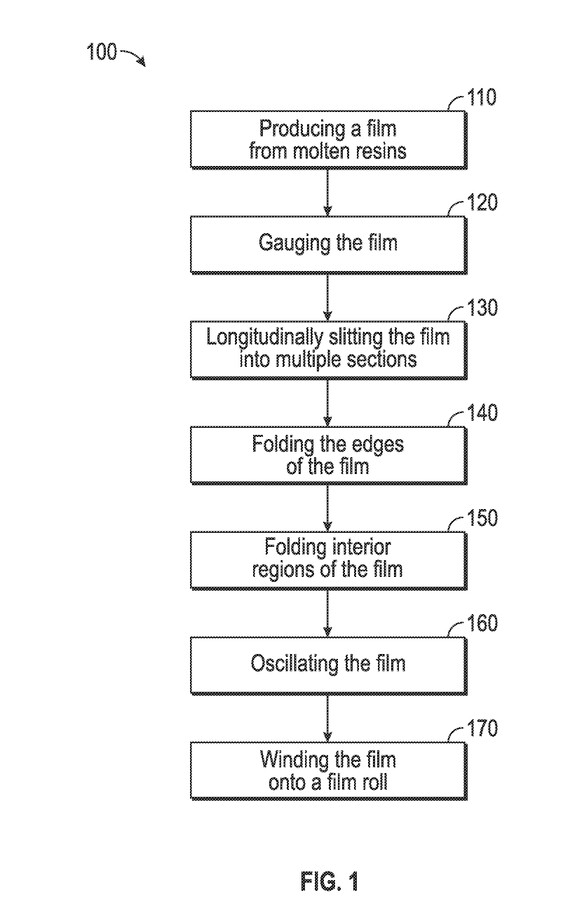

Turning to FIG. 1, the steps 100 for producing stretch film in-process, according to example embodiments, are illustrated. Specifically, according to example embodiments, the steps comprise producing a film from molten resins 110, gauging the film 120, longitudinally slitting the film into multiple sections 130, folding the edges of the film 140, folding an interior section of the film 150, oscillating the film 160, and winding the film onto a film roll 170 in a manner that prevents stacking of the folds and entraps air between the layers of film. In still other example embodiments, all of the steps are performed in-process along a single production line. In still further example embodiments, the steps are performed in a different order, and in still other example embodiments, one or more steps are eliminated without departing from the scope of the present disclosure.

Specifically, in some embodiments, the edge folding step 140 is eliminated. In some embodiments wherein the edge folding step 140 is not performed, the interior folding step 150 occurs prior to the film slitting step 130. In still other embodiments wherein the edge folding step 140 is not performed, the interior folding step 150 occurs after the film slitting step 130.

Slitting assemblies are well-known in the art, and according to example embodiments, any conventional slitting assembly is used to slit the film into multiple sections. According to further example embodiments, an interior slit is defined as a slit made somewhere within the original width of film, resulting in multiple sections of lesser width. According to still further example embodiments, each interior slit requires only one edge folding guide assembly to accommodate both adjacent film edges.

According to other example embodiments, the edges of the film are folded after the film is longitudinally slit into multiple sections. In further embodiments, interior folds are initiated into the interior web of the film following the edge folding step. However, in alternative embodiments, interior folds are initiated into the film without the edges being folded. In this embodiment, the folds are initiated prior to the film being slit, while in other embodiments, folds are initiated after the film is slit into multiple sections.

In embodiments wherein the interior folds are initiated in a film web that also includes folded edges, the interior folds are initiated prior to edge-folding. In other example embodiments, the interior folds are initiated concurrent with the edge folding. In embodiments where the user desires to maintain the web width and produce good quality edge folds, the interior folds are initiated after the edge folds have been established.

In certain embodiments, means for initiating at least one interior fold in a film web are provided.

In some embodiments, means for initiating at least one interior fold includes an interior web folding assembly. In certain embodiments, the interior web folding assembly includes interior folding guides positioned above or below the film web, or in still further embodiments, interior folding guides are positioned both above and below the film web in a matching or complimenting arrangement.

In example embodiments, means for compressing and completing the interior fold initiated by the means for initiating the at least one interior fold in a film web are provided.

In certain embodiments, a rolling assembly is used to compress and complete the at least one interior fold.

In certain embodiments, the rolling assembly comprises a roller. In those embodiments, for example, when the width of the interior fold initiated is greater than about 0.25 inches, the film passes over (or in other embodiments, under) a roller to compress and complete the interior fold.

In other embodiments, the rolling assembly comprises a nip roll assembly. In those embodiments, for example, when the width of the interior fold initiated is less than about 0.25 inches, the film passes through the nip roll assembly, which comprises a nipped set of rollers, to compress and complete the interior fold.

In still other embodiments, the rolling assembly comprises the winding roll. In those embodiments, the film passes over (or in other embodiments, under) the winding roll to compress and complete the interior fold.

In other example embodiments, the folds make the film less susceptible to failure due to tears, rough handling, dropping, or excessive stretching. Thus, in still further example embodiments, introducing and maintaining folds improves film performance.

According to certain embodiments, the number and width of the interior folds varies depending on the total width and thickness of the film, along with the desired end-use application of the film. An example embodiment comprises a 500 mm wide film, at a thickness of 10 micrometers (μm) with folded edges and three interior folds spaced evenly across the web.

According to example embodiments, wider films have more interior folds than similar, narrower films.

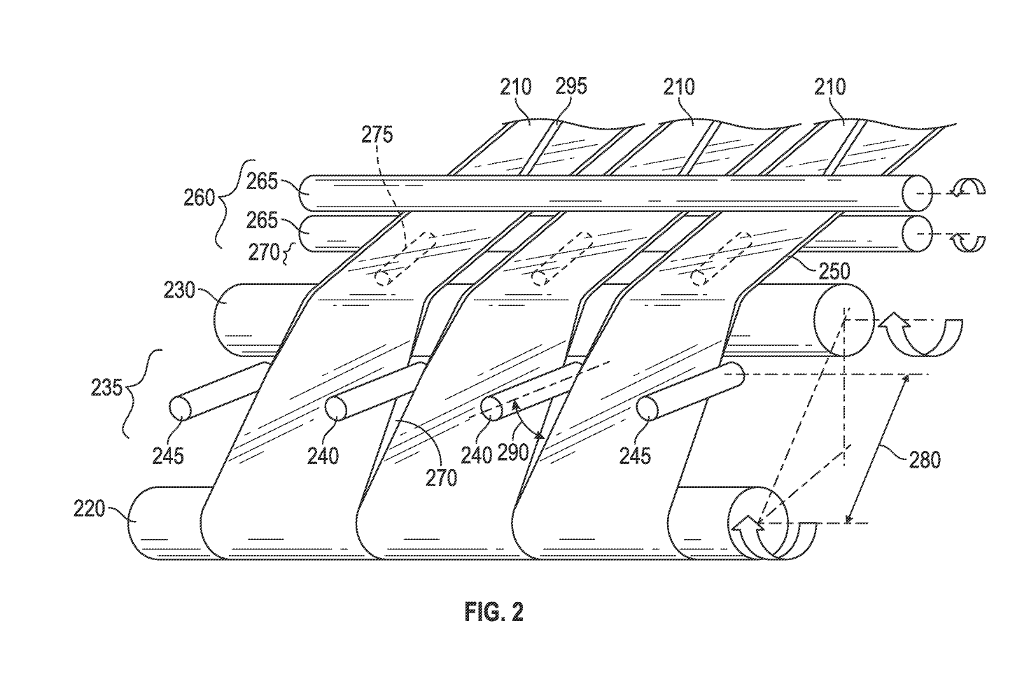

Turning next to FIG. 2, according to example embodiments, a system for folding the edges and interior sections of the film 210 comprises a first idler roll 220, a second idler roll 230, and an edge folding guide assembly 235, placed between the first idler roll 220 and the second idler roll 230. In alternative example embodiments, the edge folding guide assembly 235 is comprised of a plurality of edge folding guides 240-245, some of which are placed in the slits 270 between sections of film 210 to separate the sections of film 210. As shown in FIG. 2, the edge folding guides 240-245 are folding rods according to certain example embodiments, but other types of folding guides are also contemplated herein.

In other example embodiments, each folding guide 240 separates adjacent sections of film 210 and induces two folds 250, thereby causing an edge of each section of film to turn under 180° and cling to a bottom surface of the section of film.

In other example embodiments, each interior folding rod 240 produces two edge folds 250, while each exterior folding rod 245 produces one edge fold 250.

In further example embodiments, the system for folding edges and interior sections of the film 210 further comprises an interior web folding assembly 270 placed between the second idler roll 230 and the nip roll assembly 260. In certain embodiments, the interior web folding assembly 270 comprises a plurality of interior web folding guides 275, placed underneath the sections of film 210. In certain embodiments, the interior web folding guides 275 are folding rods, but other types of folding guides are also contemplated herein.

In further example embodiments, each interior web folding guide 275 deforms the film such that one interior web fold is initiated.

In certain embodiments, the folds are initiated by the interior web folding guides 275 by causing a wrinkle to be introduced into the film web via a folding rod or roller from above the web, below the web, or, in certain embodiments, both above and below the web.

In further embodiments, the interior web folding guides 275 are oscillated in the cross-direction of the film web, to randomly disperse the folded region(s) of the film, so as to minimize localized build-up on the finished film roll.

In embodiments where the folding guides are placed above and below the film web, the action of initiating the interior fold does not cause the film thickness to be altered in the folded region, which results in the overall film width being decreased as it passes through the interior web folding assembly.

In embodiments where the film width is altered, the film is slitted after the folds have been initiated in order to better control the final web width being wound onto the film roll.

In embodiments where the interior web folding guides are designed to locally stretch or deform the film web, the overall film width is minimally affected. In these embodiments, the film is slit either before or after the interior folds are initiated with minimal effect on the finished web width.

According to further example embodiments, each edge folding guide 240-245 is comprised of steel, aluminum, nylon, or any other material of sufficient modulus to be able to maintain rigidity. According to still further example embodiments, each edge folding guide also has a coefficient of friction that allows the edge of the film to turn back on itself, thus introducing a fold. In still further example embodiments, the diameter and placement of the edge folding guides 240-245 assist in achieving and maintaining edge folds 250 without roping or wrinkling of the film 210.

In still other example embodiments, the edge folding guides 240-245 vary from about ⅜ inch to about 1 inch in diameter, with a preferred diameter of approximately 11/16 inch. In still further example embodiments, the edge folding guides 240-245 have uniform diameter throughout their length. As an alternative, according to example embodiments, the portions of the edge folding guides 240-245 that contact the film 210 have a smaller diameter or narrow to a point to further aid in separating the sections of film 210.

According to example embodiments, the edge folding guides 240-245 are placed in the slits 270 between sections of the film 210 at a guide distance 280 and a guide angle 290. According to further example embodiments, the guide distance 280 is about ⅔ of the distance between the first idler roll 220 and the second idler roll 230, as measured from the point where the film 210 leaves the first idler roll 220 to the point where the film 210 first contacts the edge folding guides 240-245. According to still further example embodiments, the guide angle 290 between the film 210 and the edge folding guides 240-245, measured with the folding guides 240-245 leaning toward the first idler roll 220, varies from about 20° to about 90°, with a preferred angle of about 45°.

As shown in FIG. 2, according to other example embodiments, the system for folding the edges and interior sections of the film 210 also comprises a nip roll assembly 260. In other example embodiments, the nip roll assembly 260 comprises two rollers 265 pressed together, and are primarily intended to control the tension of the film 210 as it passes through the slitting assembly and the edge folding apparatus. In still other example embodiments, the nip roll assembly 260 also aids in pressing the folds 250 into the film 210, resulting in completed interior folds.

In still other embodiments, the nip roll assembly 260 aids in pressing the interior web folds 295 into a Z-shape configuration. In further example embodiments, when a nip roll assembly 260 is not employed, air entrapment occurs within the edge folds and interior web folds. In certain example embodiments, air entrapment within the edge folds and interior web folds results in a film roll with a different appearance and functionality, much like having bubble wrap.

Turning back to FIG. 1, according to example embodiments, the film is oscillated 150 and wound 160 onto film rolls. According to further example embodiments, oscillation efficiently distributes the edge folds onto the film roll. In addition, according to still further example embodiments, air is entrapped between the layers of film as the film is wound onto a film roll, making the film easier to unwind and less susceptible to damage.

In certain embodiments, the interior web folding assembly comprises a wheel above the web and a corresponding U-shaped receiver below the web.

In still other embodiments, the interior web folding assembly comprises a rod above the web which directs the film into a slot below the web, wherein the slot has a decreasing width with a corresponding increase in depth.

In another example embodiment, the interior web folding assembly comprises a folding tool and a receiving surface (e.g., a drum or the like) that imparts a negative impression corresponding to the positive impression made by the tool.

According to a still further example embodiment, the interior web folding assembly comprises one or more jets, which direct compressed air into the film to initiate interior web folds. In other embodiments, the air jet(s) force the film into a slot located below the film web to control the fold. In still other embodiments, the pressure and the nozzle of the jet are optimized in order to initiate a fold into the interior of the film web.

In still other embodiments, the interior web folding assembly comprises a supporting drum with slots and a vacuum. In embodiments incorporating the supporting drum and a vacuum, the vacuum pulls the web into the slots or grooves in the drum, that run in the machine direction to induce an interior fold.

According to a further example embodiment, the interior folds are initiated while the film is being produced in-process, using at least one roller.

According to further example embodiments, other mechanical tools that can deform a film are used to initiate interior fold(s) into the film, and are contemplated herein.

In certain embodiments, similar to the type of rods used to induce folds on the edges of the film, interior web folding rods are angled into the moving web to initiate an interior fold. In alternative embodiments, the interior folding rods are made of a low coefficient of friction material, such as aluminum, polypropylene, nylon, high density polyethylene, brass, steel, cast iron, Bakelite, phenolic compounds, glass, or fiberglass.

In other embodiments, the interior web folding rods are stiff (high modulus). Suitable materials, according to example embodiments, include steel, aluminum, brass, nylon and fiberglass. In further embodiments, the physical design of the interior web folding rods, including diameter and length, along with how the rod is supported and the length of the rod, assist in defining the inherent “stiffness” of the rod in relation to the film.

In other embodiments, the interior web folding rods are long and flexible in order to initiate the interior folds.

According to another embodiment, once the film has been extended or deformed, the folds are pressed using a nipped set of rollers 265, thereby resulting in one or more “Z” shaped folds 295 being incorporated into the interior of the film.

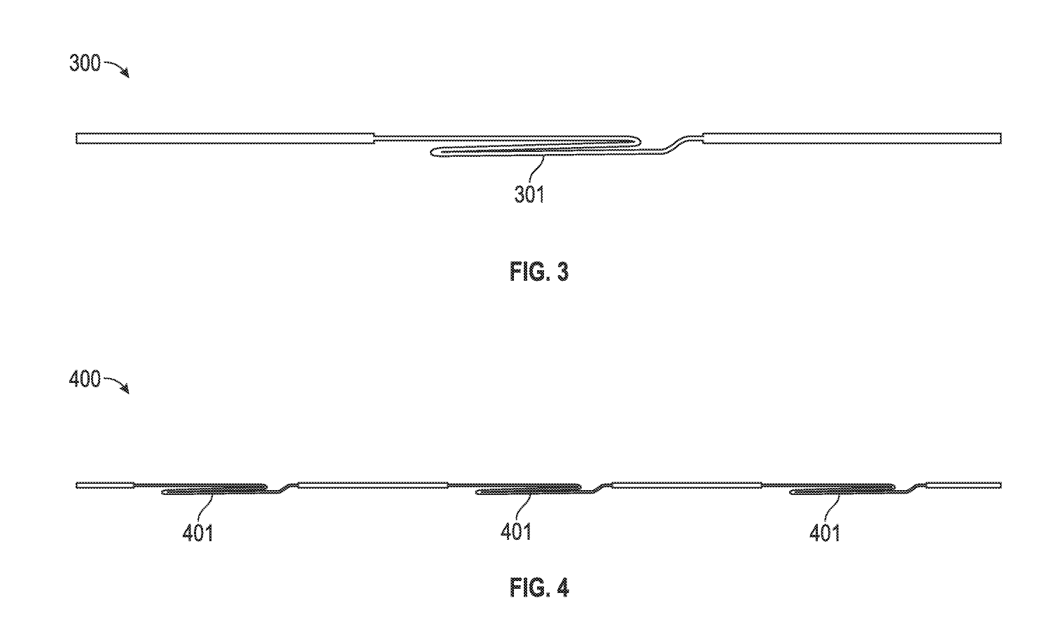

As used throughout this disclosure, an “interior fold” is a Z-shaped fold, which actually includes two folds, as illustrated in FIGS. 3 and 4.

According to various example embodiments, the “Z” folds are incorporated into any portion of the web; e.g., singularly, as shown in FIG. 3, or in multiples, as shown in FIG. 4. The “Z” or zigzag shape is apparent from a side view of the film.

FIG. 3 illustrates an embodiment wherein the resulting film 300 has only one interior fold 301. According to the embodiment of FIG. 3, the film 300 does not have folded edges. However, other embodiments, including the embodiments described by FIG. 2, comprise an interior web fold 301 and also edge folds.

FIG. 4 illustrates an embodiment wherein the resulting film 400 comprises three (3) interior folds 401. According to the embodiment of FIG. 4, the film 400 does not have folded edges. However, other embodiments have multiple interior folds as well as folded edges.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A method of folding an interior section of film in-process, said method comprising:
separating an idler roll and a rolling assembly;
positioning an interior web folding assembly between the idler roll and the rolling assembly;
passing a film web from the idler roll to the interior web folding assembly;
initiating at least one interior fold in the film web using the interior web folding assembly;
passing the film web from the interior web folding assembly to the rolling assembly; and
passing the film web beyond the rolling assembly, compressing the film web, and completing the at least one interior fold.

2. The method of claim 1, further comprising passing the film web through a nip roll assembly, thereby compressing the film web and completing the at least one interior fold.

3. The method of claim 1, further comprising passing the film web beyond the rolling assembly and compressing the film web using a winding roller to complete the at least one interior fold.

4. The method of claim 3, further comprising passing the film web above the rolling assembly and compressing the film web using a winding roller to complete the at least one interior fold.

5. The method of claim 3, further comprising passing the film web under the rolling assembly and compressing the film web using a winding roller to complete the at least one interior fold.

6. The method of claim 1, further comprising winding the film web using a winding roller, thereby compressing the film web and completing said at least one interior fold.

7. The method of claim 1, further comprising compressing the film web and completing the at least one interior fold using means for compressing the film web and completing the at least one interior fold.

8. The method of claim 1, further comprising slitting and separating the film web into multiple sections.

9. The method of claim 1, wherein said positioning an interior web folding assembly further comprises positioning at least one interior web folding guide between the idler roll and the rolling assembly.

10. The method of claim 9, wherein said positioning at least one interior web folding guide further comprises positioning at least one folding rod between the idler roll and the rolling assembly.

11. The method of claim 1, wherein said positioning an interior web folding assembly further comprises positioning at least one of: a roller, a wheel and corresponding receiver, a rod and a slot, a folding tool and a receiving surface, an air jet, and a supporting drum and a vacuum, between the idler roll and the rolling assembly.

12. The method of claim 1, further comprising coating the exterior surfaces of at least one of: the idler roll, the rolling assembly, and the interior web folding assembly with a non-stick coating.

13. The method of claim 1, further compromising oscillating the film web using the interior web folding assembly.

14. A method of folding an interior section of film in-process, said method comprising:
passing a film web through an interior web folding assembly;
initiating at least one interior fold in the film web using the interior web folding assembly; and
subsequently compressing the film web until the at least one interior fold is completed.

15. An apparatus for producing at least one interior fold in a film in-process, the apparatus comprising:
an idler roll separated from a rolling assembly; and
an interior web folding assembly positioned between the idler roll and the rolling assembly.

16. The apparatus of claim 15, wherein the rolling assembly comprises a nip roll assembly.

17. The apparatus of claim 15, wherein the rolling assembly comprises a winding roller.

18. The apparatus of claim 17, the rolling assembly further comprising a roller.

19. The apparatus of claim 15, further comprising a slitting apparatus for slitting the film web in adjacent sections.

20. The apparatus of claim 15, wherein the interior web folding assembly comprises at least one interior web folding guide.

21. The apparatus of claim 20, wherein the at least one interior web folding guide is a folding rod.

22. The apparatus of claim 15, wherein the interior web folding assembly comprises at least one of: a roller, a wheel and corresponding receiver, a rod and a slot, a folding tool and a receiving surface, an air jet, and a supporting drum and a vacuum.

23. The apparatus of claim 15, wherein the exterior surfaces of at least one of the idler roll, the rolling assembly, and the interior web folding assembly are coated with a non-stick coating.

24. The apparatus of claim 15, wherein the interior web folding assembly is oscillatable in the cross-direction of the film web.

25. An apparatus for producing at least one interior fold in a film in-process, the apparatus comprising: means for initiating at least one interior fold in a film web; and means for compressing the film web and completing the at least one interior fold.
